(19) United States
(12) Patent Application Publication
(10) Pub. No.: US 2016/0255647 A1
(43) Pub. Date: Sep. 1, 2016

(54) DEVICE-TO-DEVICE DATA CHANNEL SIGNALING

(71) Applicant: FUJITSU LIMITED, Kawasaki-shi, Kanagawa (JP)

(72) Inventors: Chenxi ZHU, Fairfax, VA (US); Akira ITO, San Jose, CA (US)

(73) Assignee: FUJITSU LIMITED, Kawasaki-shi, Kanagawa (JP)

(21) Appl. No.: 14/908,526

(22) PCT Filed: May 12, 2014
(86) PCT No.: PCT/US2014/037713

§ 371 Date: Jan. 28, 2016

Related U.S. Application Data
(60) Provisional application No. 61/907,970, filed on Nov. 22, 2013.

(51) Int. Cl. H04W 72/12; H04W 72/04

(52) U.S. Cl. CPC H04W 72/1278; H04W 72/0406; H04W 72/1231

(57) ABSTRACT

A method of communicating wireless communication resource scheduling may include determining a scheduling of a wireless communication resource associated with a device-to-device (D2D) data channel transmission over a D2D data channel. The method may also include transmitting the scheduled wireless communication resource associated with the D2D data channel transmission over a D2D control channel in a D2D control channel transmission. The D2D control channel transmission may be transmitted before transmitting the D2D data channel transmission. The D2D control channel may be separate from the D2D data channel.

### FIELD

The present disclosure relates to device-to-device (D2D) data channel signaling.

### BACKGROUND

The proliferation of smartphones, tablets, laptop computers, and other electronic devices (referred to generally as “wireless devices”) that use wireless communication networks has created an increased demand for ubiquitous and continuous wireless voice and data access. Device-to-device (D2D) communication may help satisfy this demand. For example, D2D communication may be performed between wireless devices and may allow the wireless devices to communicate information with each other. This D2D communication may allow for reuse of wireless communication resources, which may help satisfy the demand for wireless voice and data access.

The subject matter claimed herein is not limited to embodiments that solve any disadvantages or that operate only in environments such as those described above.

Rather, this background is only provided to illustrate one example technology area where some embodiments described herein may be practiced.

### SUMMARY

According to an aspect of an embodiment, a method of communicating wireless communication resource scheduling may include determining a scheduling of a wireless communication resource associated with a device-to-device (D2D) data channel transmission over a D2D data channel. The method may also include transmitting the scheduled wireless communication resource associated with the D2D data channel transmission over a D2D control channel in a D2D control channel transmission. The

D2D control channel transmission may be transmitted before transmitting the D2D data channel transmission. The D2D control channel may be separate from the D2D data channel.

The object and advantages of the embodiments will be realized and achieved at least by the elements, features, and combinations particularly pointed out in the claims. It is understood that both the foregoing general description and the following detailed description are exemplary and explanatory and are not restrictive of the present disclosure, as claimed.

### BRIEF DESCRIPTION OF THE DRAWINGS

Example embodiments will be described and explained with additional specificity and detail through the use of the accompanying drawings in which:

FIG. 1 illustrates an example wireless communication network configured to perform device-to-device (D2D) data channel signaling;

FIG. 2 illustrates an example embodiment of a control unit that may be configured to direct a system to perform D2D data channel signaling; and

FIG. 3 is a flowchart of an example method of performing D2D data channel signaling.

### DESCRIPTION OF EMBODIMENTS

Device-to-device (D2D) communication may allow for direct data transmission between wireless devices, which in some embodiments may be an overlay to regular cellular communications. D2D communication may increase network capacity by allowing for spatial multiplexing, which may increase the reuse and sharing of wireless communication resources. Additionally, a D2D link between wireless devices may have improved channel quality as compared to a link between a wireless device and an access point of a wireless communication system. Further, the communication of data between wireless devices through D2D communication may be direct instead of being relayed by an access point, which may reduce the usage of wireless communication resources. The direct communication may also reduce delays that may be associated with relaying data through the access point. In some instances, D2D communication may also extend the coverage of a cell associated with an access point by relaying information to and from the access point via a D2D relay. In the present disclosure, wireless devices that are involved in D2D communications may be referred to as “D2D devices.” Additionally, a D2D device that transmits a D2D communication may be referred to as a “transmitting D2D device.” Similarly, a D2D device that receives a D2D communication may be referred to as a “receiving D2D device.”In some embodiments, D2D communication may include D2D transmissions from a transmitting D2D device to one other receiving D2D device (which may be referred to as “D2D unicast”). D2D communication may also include D2D transmissions from the transmitting D2D device to a subset of receiving D2D devices within a transmission range of the transmitting D2D device (which may be referred to as “D2D group cast”). D2D communication may also include D2D transmissions from the transmitting D2D device to all receiving D2D devices within the transmission range of the transmitting D2D device (which may be referred to as “D2D broadcast”).

As detailed below, in some embodiments, data intended for one or more receiving D2D devices may be transmitted from the transmitting D2D device to the one or more receiving D2D devices over a D2D data channel that may also be referred to as a D2D Physical Shared Channel (“D2D-PSCH”). Additionally, information that may be used by the receiving D2D devices to receive and decode the D2D data channel transmission may be communicated over a D2D control channel that may also be referred to as a D2D Physical Control Channel (“D2D-PCCH”). As described in detail below, scheduling (assigning) of wireless communication resources for D2D communications over the D2D data channel may be performed and then transmitted using the D2D control channel.

Embodiments of the present disclosure will be explained with reference to the accompanying drawings.

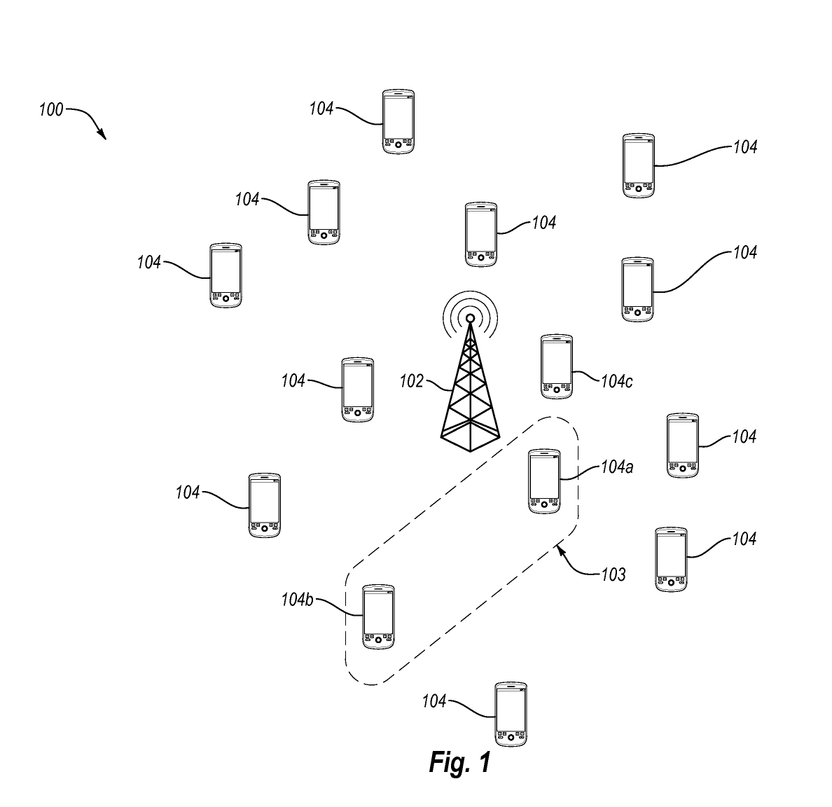

FIG. 1 illustrates an example wireless communication network 100 (referred to hereinafter as the “network 100”) configured to perform D2D data channel (D2D-PSCH) signaling, arranged in accordance with at least one embodiment of the present disclosure. The network 100 may be configured to provide wireless communication services to one or more wireless devices 104 via one or more access points 102. The wireless communication services may be voice services, data services, messaging services, and/or any suitable combination thereof. The network 100 may include a Frequency Division Multiple Access (FDMA) network, an Orthogonal FDMA (OFDMA) network, a Code Division Multiple Access (CDMA) network, a Time Division Multiple Access (TDMA) network, and/or any other suitable wireless communication network. In some embodiments, the network 100 may be configured as a third generation (3G) wireless communication network and/or a fourth generation (4G) wireless communication network. In these or other embodiments, the network 100 may be configured as a long term evolution (LTE) wireless communication network.

The access point 102 may be any suitable wireless communication network communication point and may include, by way of example but not limitation, a base station, an evolved node “B” (eNB) base station, a remote radio head (RRH), or any other suitable communication point. The wireless devices 104 may include any devices that may use the network 100 for obtaining wireless communication services and may include, by way of example and not limitation, a cellular phone, a smartphone, a personal data assistant (PDA), a laptop computer, a personal computer, a tablet computer, or any other similar device.

At least some of the wireless devices 104 may be configured to perform D2D communications. For example, a wireless device 104a and a wireless device 104b may be configured as a D2D pair 103. In the illustrated example, the wireless device 104a may be configured to transmit D2D signals to the wireless device 104b such that the wireless device 104b may receive the D2D signals. Therefore, the wireless device 104a may be referred to as a “transmitting D2D device 104a” with respect to the D2D pair 103 and the wireless device 104b may be referred to as a “receiving D2D device 104b” with respect to the D2D pair 103 in the present disclosure. In the illustrated embodiment, the transmitting D2D device 104a and the receiving D2D device 104b are depicted as performing unicast D2D communications; however, the teachings described herein with respect to D2D communications may also include D2D group cast or D2D broadcast communications.

In some embodiments, D2D pairs and groups chosen for D2D group cast and D2D broadcast may be determined based on D2D neighbor discovery. D2D neighbor discovery may be any suitable signaling mechanism that may be used to determine which wireless devices 104 may be suited for performing D2D communications with each other. In some embodiments, D2D neighbor discovery may be based on the locations of the wireless devices 104. In these or other embodiments, D2D neighbor discovery may be coordinated by the access point 102.

The transmitting D2D device 104a may be configured to transmit data intended for the receiving D2D device 104b over the D2D data channel via one or more D2D data channel transmissions. In some embodiments, the D2D data channel may use the same wireless communication resources as and may be configured according to, a Physical Uplink Shared Channel (PUSCH) that may also be used for uplink communications between the wireless devices 104 and the access point 102. For example, the D2D data channel may use a Single Carrier Frequency Division Multiple Access (SC-FDMA) scheme and may employ the use of the Cyclic Redundancy Check (CRC), encoding, rate matching, scrambling, and Demodulation Reference Signal (DMRS) schemes included in the PUSCH structure.

The transmitting D2D device 104a may also be configured to transmit information (e.g., data) that may be used by the receiving D2D device 104b to receive and decode the D2D data channel transmissions over a D2D control channel (D2D-PCCH) via one or more D2D control channel transmissions. In some embodiments, the D2D control channel may use the same wireless communication resources as and may be configured according to, a Physical Uplink Control Channel (PUCCH) structure that may also be used for uplink communications between the wireless devices 104 and the access point 102. In these or other embodiments, the D2D control channel may be separate from the D2D data channel.

For example, in some embodiments, the D2D control channel may be a separate physical channel from the D2D data channel. In other embodiments, the D2D control channel may be substantially the same physical channel as the D2D data channel but with control information encoded thereon. Additionally, in these or other embodiments, the D2D control channel may include a relatively small amount of designated wireless communication resources (e.g., resource blocks) of its physical channel such that the receiving D2D device 104b may scan the designated resource blocks for D2D control channel transmissions. In contrast, the D2D data channel may include a larger number of resource blocks in which scheduling of the D2D data channel transmissions may be performed, as explained further below. Further, in these or other embodiments, the packet configuration of the D2D control channel may be different from the packet configuration of the D2D data channel such that the D2D control channel and the D2D data channel may be different and/or separate.

In some embodiments, the D2D control channel transmissions may indicate a Modulation and Coding Scheme (MCS) that may be used by the D2D data channel, the wireless communication resources (e.g., time, frequency) and associated scheduling used for the D2D data channel transmissions, as well as an identifier (ID) that may be associated with the transmission of D2D data between the transmitting D2D device 104a and the receiving D2D device 104b. The ID may be a session ID (or partial ID) associated with the D2D pair 103 and may identify the transmitting D2D device 104a and/or the receiving D2D device 104b. In some embodiments, the ID may be a Radio Network Temporary Identifier (RNTI) associated with the D2D pair 103. Additionally, in embodiments related to D2D group cast or D2D broadcast, the ID may be an associated RNTI that may be assigned to the respective group of wireless devices performing D2D communications. The ID may be used to reduce the load of receiving D2D devices blindly attempting to decode D2D data included in the D2D data channel by allowing the receiving D2D devices to identify which D2D communications are intended for them. In some embodiments, the ID may be assigned by the access point 102 or a higher layer of the network 100.

In some instances, the packets or transmission blocks of a D2D data channel transmission may be of varying lengths such that the receiving D2D device 104b may not be able to rely on a pre-determined packet size and a corresponding pre-determined range of wireless communication resources in determining when a packet begins or ends and which wireless communication resources correspond to which packet. For example, higher layer data packets such as Internet Protocol (IP) packets may have varying lengths depending on the amount of information that may be communicated via the IP packets. Therefore, the amount of wireless communication resources that may be used to communicate the IP packets may also vary depending on the amount of information that may be communicated via the IP packets.

As such, in some embodiments, the D2D control channel transmissions may include a new data indicator (NDI). In some embodiments, the NDI may indicate a starting wireless communication resource (e.g., a starting time slot) for each variable length packet such that the receiving D2D device 102b may know which wireless communication resources correspond to which packets. In these or other embodiments, the NDI may indicate a starting wireless communication resource for a particular variable length packet and then may indicate a corresponding range of wireless communication resources that may be used by the particular variable length packet as well as corresponding ranges of wireless communication resources for any subsequent variable length packets. Therefore, the NDI may allow for the communication of variable length packets from the transmitting D2D device 102a to the receiving D2D device 102b.

The D2D control channel transmissions may be transmitted by the transmitting D2D device 104a before the transmitting D2D device 104a transmits the corresponding D2D data channel transmissions. Accordingly, the receiving D2D device 104b may receive the appropriate scheduling and decoding information for the corresponding D2D data channel transmissions before the corresponding D2D data channel transmissions are transmitted. As indicated above, in some embodiments, the D2D control channel may include a relatively small set of wireless communication resources that are designated for D2D control channel transmissions. The receiving D2D device 104b may scan the wireless communication resources designated for D2D control channel transmissions to receive the D2D control channel transmissions Therefore, the transmitting D2D device 104a may schedule a D2D control channel transmission within the designated D2D control channel wireless communication resources without having to communicate the specific scheduling information to the receiving D2D device 104b in order for the receiving D2D device 104b to receive the corresponding D2D control channel communication.

In some embodiments, the D2D control channel transmissions may be transmitted in the same wireless communication timing subframe as the D2D data channel transmissions. In other embodiments, the D2D control channel transmissions may be transmitted in a different subframe than the D2D data channel transmissions.

The transmission in the same or different subframes may be based on the capability of the transmitting D2D device 104a and/or power limitations of the transmitting D2D device 104a, for example. Additionally, being able to transmit in the same or different subframes may allow for flexibility in scheduling the D2D data channel transmissions.

The scheduling of wireless communication resources such as frequency and timing for the D2D data channel transmissions may be performed by the transmitting D2D device 104a and/or the access point 102. For example, in some embodiments, the transmitting D2D device 104a may directly perform the scheduling to determine the scheduling. In these or other embodiments, the access point 102 may perform the scheduling and may communicate the scheduling information to the transmitting D2D device 104a such that the transmitting D2D device may determine the scheduling based on the received scheduling information.

The scheduling may be performed to help reduce interference and/or the collision of different D2D communications from different transmitting D2D devices. For example, frequency and/or time hopping of consecutive D2D data channel transmissions from the transmitting D2D device 104a may be scheduled to improve performance of D2D data channel transmissions and/or to reduce collisions and/or interference from or with other D2D data channel transmissions by other transmitting D2D devices. Additionally, when uplink channel resources are used for D2D data channel transmissions, the scheduling may be performed to reduce interference between the D2D data channel transmissions and uplink signals communicated by other wireless devices 104 to the access point 102. In some embodiments, the frequency hopping may be between different Physical Resource Blocks (“PRB”) in the same subframe, which may improve frequency diversity. In these or other embodiments, the frequency hopping between PRBs may be performed by default such that it may be performed without being indicated or signaled.

In some embodiments, the time and/or frequency hopping may be a pre-defined psuedo-random pattern that may be determined based on a User Equipment (UE) ID that may be associated with the transmitting D2D device 104a. In these or other embodiments, the pre-defined psuedo-random pattern may be based on a transmission session ID associated with the D2D communications. Additionally or alternatively, the transmitting D2D device 102a may communicate the pre-defined scheduling information for the D2D data channel transmissions periodically or psuedo periodically to the receiving D2D device 102b.

In these or other instances, the scheduling for D2D data channel transmissions may be flexibly assigned instead of following a set pattern. In some embodiments, the dynamic scheduling may be communicated to the receiving D2D device 104b via one or more D2D control channel transmissions that may be communicated on a periodic or psuedo-periodic basis. The flexible scheduling may be based on D2D data channel conditions such that the scheduling of D2D data channel transmissions may be dynamically adjusted to reduce interference with other D2D data channel transmissions.

For example, in some embodiments, the transmitting D2D device 104a may be configured to transmit reference signals (e.g., a sounding reference signal (SRS)) that may be received by the receiving D2D device 104b. The receiving D2D device 104b may be configured to determine channel conditions (e.g., channel quality information such as interference) of one or more D2D channels between the transmitting D2D device 104a and the receiving D2D device 104b based on the received reference signals. In these or other embodiments, the receiving D2D device 104b may have received previous D2D data channel communications (which may be a type of signal) over one or more D2D channels. The receiving D2D device 104b may accordingly determine the channel conditions associated with the D2D channels based on previously received D2D data channel transmissions.

The determined channel conditions and D2D channels may be associated with different wireless communication resources such that the wireless communication resources that yield favorable channel conditions may be identified and used in the scheduling of D2D data channel transmissions. For example, the wireless communication resources associated with D2D data channels that experience the least amount of interference may be identified and selected for the D2D data channel transmissions. In some embodiments, the receiving D2D device 104b may be configured to communicate the channel conditions to the access point 102. The access point 102 may in turn relay the channel conditions to the transmitting D2D device 104a, which, in some embodiments, may directly determine the scheduling based on the received channel conditions. In other embodiments, the access point 102 may perform the scheduling based on the received channel conditions and may relay the associated scheduling information to the transmitting D2D device 104a such that the transmitting D2D device 104a may determine the scheduling based on the scheduling information received from the access point 102. In these or other embodiments, the relaying of information from the receiving D2D device 104b to the transmitting D2D device 104a via the access point 102 may be performed via a physical (PHY) layer feedback of the network 100.

In these or other embodiments, the transmitting D2D device 104a may be configured to estimate or determine channel conditions (e.g., channel quality) based on signals that may be received at the transmitting D2D device 104a that may be transmitted in similar wireless communication resources. For example, the transmitting D2D device 104a may measure a signal power of received D2D data channel transmissions transmitted by other transmitting D2D devices in any number of D2D data channel transmission resources such as frequency and time. The transmitting D2D device 104a may then estimate interference that may be associated with its D2D data channel transmissions transmitted in similar wireless communication resources based on the signal power of the received D2D data channel transmissions. When the determined interference is deemed too high (e.g., exceeds a threshold) for a particular scheduling scheme, the transmitting D2D device 104a and/or the access point 102 may then select a different scheduling scheme for its D2D data channel transmission that may be associated with lower interference. In some embodiments, the D2D transmitting device 104a may perform the same analysis with respect to uplink signals that may be transmitted using similar wireless communication resources as the D2D data channel transmissions and that may be received at the D2D transmitting device 104a.

Accordingly, frequency and/or time hopping associated with the D2D data channel scheduling may be dynamically determined based on channel conditions in some embodiments instead of following a default routine. A subsequent D2D control channel transmission may reflect the dynamic scheduling such that the scheduling may be performed on a per-D2D control channel transmission and associated D2D data channel transmission basis in some instances to reflect changes in the scheduling that may be based on changing channel conditions.

The D2D control channel transmission may carry the scheduling information, which may be received by the receiving D2D device 104b such that the receiving D2D device 104b may know in which wireless communication resources one or more corresponding D2D data channel transmissions may be transmitted. For example, the D2D control channel transmission may include the timing of corresponding D2D data channel transmissions such that the receiving D2D device 104b may know when to expect the corresponding D2D data channel transmissions. In some embodiments, the timing may reflect in which subframe the corresponding D2D data channel transmissions may be transmitted. Additionally, the D2D control channel transmissions may indicate which frequency domain resources (e.g., which PRB) may be assigned to the corresponding D2D data channel transmissions. In some embodiments, the scheduling information may be jointly encoded with other control information (e.g., MCS and ID) that may be included in the D2D control channel transmissions.

In some embodiments, the D2D control channel transmission may be configured to indicate the scheduling of more than one D2D data channel transmission. In these embodiments, the scheduling of wireless communication resources may be performed for the multiple D2D data channel transmissions before the D2D control channel transmission indicating the scheduling is transmitted. The scheduling may be a periodic repetition of wireless communication resources in some embodiments and in other embodiments may follow a pre-defined, signaled (e.g., by the access point 102), or agreed upon time/frequency permutation pattern.

In these or other embodiments, the scheduling may be dynamic scheduling that is similar to the dynamic scheduling described above. For example, during dynamic scheduling, a scheduling pattern may be selected that has reduced interference over other scheduling patterns. In some embodiments, whether or not the scheduling repeats or follows a specific permutation may depend on a Radio Resource Control (RRC) configuration of the D2D control channel transmissions.

Accordingly, in accordance with the present disclosure, one or more wireless devices 104 of the network 100 may be configured to perform a D2D data channel signaling mechanism that may be used to communicate wireless communication resource scheduling information (e.g., timing and frequency assignments) for upcoming D2D data channel transmissions. Modifications, additions, or omissions may be made to the network 100 without departing from the scope of the present disclosure. For example, in some embodiments, the D2D communications may be performed in instances where the receiving D2D device 104b may be outside of the coverage of the network 100 and its associated access points.

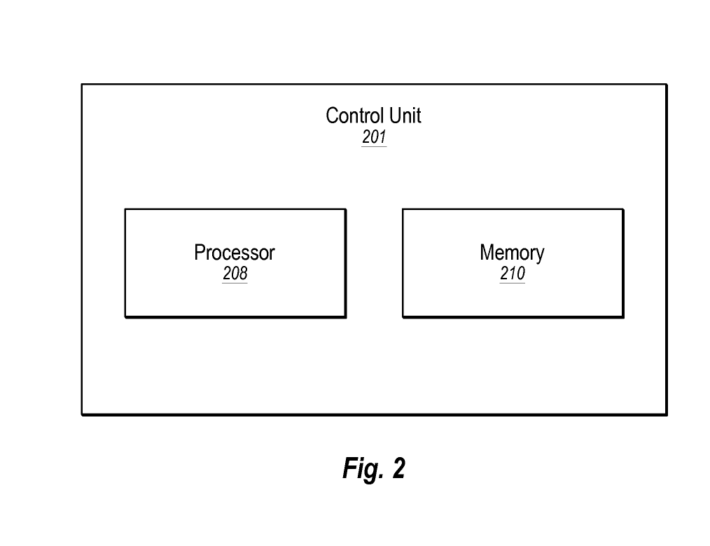

FIG. 2 illustrates an example embodiment of a control unit 201 that may be configured to direct a system to perform D2D data channel signaling as explained above, arranged in accordance with at least one embodiment of the present disclosure. For example, in some embodiments, the control unit 201 may be included in the transmitting D2D device 104a, the receiving D2D device 104b, and/or the access point 102 of FIG. 1 and may be configured to direct and/or perform one or more operations of the transmitting D2D device 104a, the receiving D2D device 104b, and/or the access point 102.

The control unit 201 may include a processor 208 and memory 210. The processor 208 may be any suitable special-purpose or general-purpose computer, computing entity, or processing device including various computer hardware or software modules. For example, the processor 208 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, it is understood that the processor 208 may include any number of processors configured to perform any number of operations.

The memory 210 may include computer-readable media for carrying or having computer-executable instructions or data structures stored thereon. Such computer-readable media may be any available media that may be accessed by a general-purpose or special-purpose computer. By way of example, and not limitation, such computer-readable media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media. Computer-executable instructions may include, for example, instructions and data which cause the processor 208 to perform a certain function or group of functions.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general-purpose hardware), specific hardware implementations or a combination of software and specific hardware implementations are also possible and contemplated. In this description, a “computing entity” may be any computing system as previously defined herein, or any module or combination of modules running on a computing system.

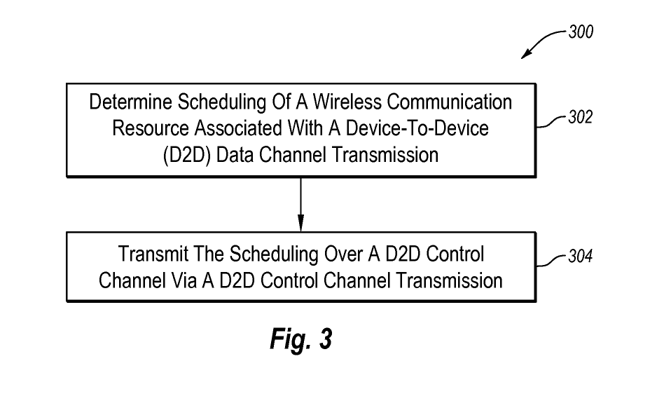

FIG. 3 is a flowchart of an example method 300 of performing D2D data channel signaling, arranged in accordance with at least one embodiment of the present disclosure. The method 300 may be implemented, in some embodiments, by one or more control units included in one or more wireless communication devices and/or access points, such as the control unit 201 of FIG. 2. For example, in some instances, the method 300 may be performed by a control unit included in the transmitting D2D device 104a of FIG. 1. In these or other embodiments, performance of the method 300 by the transmitting D2D device may allow for the transmitting D2D device to perform D2D communications with a receiving D2D device that is outside of a coverage area of access points of a wireless communication network configured to provide wireless communications service to the receiving D2D device. Accordingly, the receiving D2D device may receive wireless communication service via the transmitting D2D device even though the receiving D2D device may be outside of the typical coverage area of the wireless communication network. Although illustrated as discrete blocks, various blocks of the method 300 may be divided into additional blocks, combined into fewer blocks, or eliminated, depending on the desired implementation.

The method 300 may begin at block 302, where scheduling of a wireless communication resource associated with a device-to-device (D2D) data channel transmission over a D2D data channel may be determined. The wireless communication resource may be a time and/or frequency resource that may be used to transmit the D2D data channel transmission. In some embodiments, the scheduling may be performed by a transmitting D2D device or an access point based on channel conditions such as interference. In these or other embodiments, the channel conditions may be determined by the transmitting D2D device (e.g., the transmitting D2D device 104a) and/or a receiving D2D device (e.g., the receiving D2D device 104b) as described above. For example, interference associated with multiple wireless communication resources may be estimated and the wireless communication resource with the lowest amount of interference may be scheduled for the D2D data channel transmission.

In these or other embodiments, the scheduling may follow any suitable frequency and/or time hopping scheme. The hopping may follow a pre-determined hopping scheme such as a periodic repetition or a pre-defined time and/or frequency hopping permutation. In these or other embodiments, the hopping may be based on determined channel conditions. In some instances, the hopping may include frequency hopping that is between two or more PRBs within a same subframe of the D2D data channel transmission. Additionally, in some embodiments, the scheduling may be performed for multiple D2D data channel transmissions. The scheduling for multiple D2D data channel transmissions may also follow some sort of hopping scheme.

At block 304, the scheduled wireless communication resource associated with the D2D data channel transmission may be transmitted over a D2D control channel via a D2D control channel transmission. The D2D control channel may be separate from the D2D data channel and the D2D control channel transmission may be performed before the D2D data channel transmission. Therefore, the receiving D2D device may receive the scheduling information such that the receiving D2D device may know when and in which frequency to expect the D2D data transmission.

The D2D control channel transmission may also include other information such as the MCS that may be used by the D2D data channel transmission as well as an ID associated with the D2D communications between the transmitting D2D device and the receiving D2D device. In some embodiments, the D2D control channel transmission may include scheduling information for more than one D2D data channel transmission. In these and other embodiments, the D2D control channel transmission may also include a determined and/or pre-defined hopping scheme.

Therefore, the method 300 may be used to perform signaling of D2D data channel transmissions. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiment.

For example, in some embodiments, the method 300 may include steps associated with the transmitting D2D device receiving channel condition information from the receiving D2D device based on the D2D data channel transmissions that may be received by the receiving D2D device. The D2D transmitting device may accordingly base scheduling of subsequent D2D data transmissions based on the received channel condition information. In these or other embodiments, the method 300 may include steps associated with the transmitting D2D device determining channel conditions based on one or more other signals transmitted using similar wireless communication resources (e.g., D2D data channel transmissions transmitted by one or more other D2D transmitting devices and/or uplink signals transmitted to the access point), as explained above.

All examples and conditional language recited herein are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of performing device-to-device (D2D) data channel signaling, the method comprising:
determining a scheduling of a wireless communication resource associated with a device-to-device (D2D) data channel transmission over a D2D data channel; and
transmitting the scheduled wireless communication resource associated with the D2D data channel transmission over a D2D control channel in a D2D control channel transmission before transmitting the D2D data channel transmission, the D2D control channel being separate from the D2D data channel.

2. The method of claim 1, further comprising determining the scheduling of the wireless communication resource based on at least one of frequency and time hopping.

3. The method of claim 2, wherein the frequency hopping is between two or more Physical Resource Blocks (PRBs) within a same subframe of the D2D data channel transmission.

4. The method of claim 1, further comprising:
estimating interference associated with a plurality of wireless communication resources associated with the D2D data channel transmissions; and
determining the scheduling of the wireless communication resource from the plurality of wireless communication resources based on the estimated interference.

5. The method of claim 4, wherein a receiving D2D wireless device configured to receive the D2D data channel transmission and the D2D control channel transmission is configured to estimate the interference based on one or more signals transmitted by a transmitting D2D wireless device configured to transmit the D2D data channel transmission and the D2D control channel transmission.

6. The method of claim 4, wherein a receiving D2D wireless device configured to receive the D2D data channel transmission and the D2D control channel transmission is configured to estimate the interference based on one or more other D2D data channel transmissions transmitted by one or more other transmitting D2D devices.

7. The method of claim 1, wherein the D2D control channel transmission further includes one or more of a Modulation and Coding Scheme (MCS) used by the D2D data channel, an identifier (ID) associated with the transmission of D2D data between a transmitting D2D wireless device and one or more receiving D2D wireless devices, and a new data indicator (NDI) indicating a range of wireless communication resources for one or more variable length packets of the D2D data channel transmission.

8. The method of claim 1, wherein the D2D data channel transmission and the D2D control channel transmission are transmitted by a transmitting D2D wireless device to a receiving D2D wireless device, the receiving D2D wireless device being out of a coverage area of a wireless communication network configured to provide wireless communication services to the receiving D2D wireless device.

9. The method of claim 1, further comprising:
determining a scheduling of a plurality of wireless communication resources for a plurality of D2D data channel transmissions; and
transmitting the scheduled plurality of wireless communication resources over the D2D control channel transmission.

10. The method of claim 9, wherein determining the scheduling of the plurality of wireless communication resources follows one or more of a periodic repetition, a pre-defined time and frequency permutation, and a signaled time and frequency permutation.

11. The method of claim 9, further comprising transmitting the scheduled plurality of wireless communication resources over the D2D control channel transmission on a periodic or a psuedo-periodic basis.

12. The method of claim 1, wherein the D2D control channel includes a pre-defined set of wireless communication resources and the method further comprises transmitting the D2D control channel transmission over a wireless communication resource selected from the pre-defined set of wireless communication resources.

13. A computer-readable storage medium configured to store instructions that cause a system to perform operations for performing device-to-device (D2D) data channel signaling, the operations comprising:
determining a scheduling of a wireless communication resource associated with a device-to-device (D2D) data channel transmission over a D2D data channel; and
transmitting the scheduled wireless communication resource associated with the D2D data channel transmission over a D2D control channel in a D2D control channel transmission before transmitting the D2D data channel transmission, the D2D control channel being separate from the D2D data channel.

14. The computer-readable storage medium of claim 13, wherein the operations further comprise determining the scheduling of the wireless communication resource based on at least one of frequency and time hopping.

15. The computer-readable storage medium of claim 14, wherein the frequency hopping is between two or more Physical Resource Blocks (PRB's) within a same subframe of the D2D data channel transmission.

16. The computer-readable storage medium of claim 13, wherein the operations further comprise:
estimating interference associated with a plurality of wireless communication resources associated with the D2D data channel transmissions; and
determining the scheduling of the wireless communication resource from the plurality of wireless communication resources based on the estimated interference.

17. The computer-readable storage medium of claim 16, wherein:
the D2D data channel transmission and the D2D control channel transmission are transmitted by a transmitting D2D device; and
estimating the interference is based on one or more other D2D data channel transmissions transmitted by one or more other transmitting D2D devices that are not the transmitting D2D device.

18. The computer-readable storage medium of claim 13, wherein the D2D data channel transmission and the D2D control channel transmission are transmitted by a transmitting D2D wireless device to a receiving D2D wireless device, the receiving D2D wireless device being out of a coverage area of a wireless communication network configured to provide wireless communication services to the receiving D2D wireless device.

19. The computer-readable storage medium of claim 13, wherein the operations further comprise:
determining a scheduling of a plurality of wireless communication resources for a plurality of D2D data channel transmissions; and
transmitting the scheduled plurality of wireless communication resources over the D2D control channel transmission.

20. A wireless device comprising:
a computer-readable storage medium configured to store instructions; and
one or more processors configured to execute the instructions to cause the wireless device to perform operations for performing device-to-device (D2D) data channel signaling, the operations comprising:
determining a scheduling of a wireless communication resource associated with a device-to-device (D2D) data channel transmission over a D2D data channel; and
transmitting the scheduled wireless communication resource associated with the D2D data channel transmission over a D2D control channel in a D2D control channel transmission before transmitting the D2D data channel transmission, the D2D control channel being separate from the D2D data channel.

21. The wireless device of claim 20, wherein the operations further comprise:
estimating interference associated with a plurality of wireless communication resources associated with the D2D data channel transmissions; and
determining the scheduling of the wireless communication resource from the plurality of wireless communication resources based on the estimated interference.

22. The wireless device of claim 20, wherein the operations further comprise:
determining a scheduling of a plurality of wireless communication resources for a plurality of D2D data channel transmissions; and
transmitting the scheduled plurality of wireless communication resources over the D2D control channel transmission.
